(19) United States
(12) Patent Application Publication
(10) Pub. No.: US 2024/0280808 A1
(43) Pub. Date: Aug. 22, 2024

(54) HEAD-UP DISPLAY AND METHOD FOR DESIGNING HEAD-UP DISPLAY

(71) Applicant: Nippon Seiki Co., Ltd., Niigata (JP)

(72) Inventor: Hatsuhiko NISHIMURA, Niigata (JP)

(21) Appl. No.: 18/563,661

(22) PCT Filed: May 24, 2022
(86) PCT No.: PCT/JP2022/021188

§ 371 Date: Nov. 22, 2023

(30) Foreign Application Priority Data
May 25, 2021 (JP) 2021-087379

(51) Int. Cl. G02B 27/01; B60K 35/23; G02B 5/30; G02B 27/00

(52) U.S. Cl. CPC G02B 27/0101; B60K 35/23; G02B 5/3083; G02B 27/0012; B60K 2360/25

(57) ABSTRACT

A head-up display includes a display element that emits display light indicating vehicle information, a case that accommodates the display element and has an emission port from which the display light is emitted to the outside, an optical element including a translucent dust cover that covers the emission port, and a phase element that is constituted from a plurality of phase difference plates having different polarization characteristics and is disposed at a prescribed inclination with respect to the principal ray of the display light. The phase element is designed by a first step for setting a light propagation characteristic of the optical element, and a second step for setting a target value of emission light of the optical element and calculating the polarization characteristics of each of the plurality of phase difference plates and the inclination serving as an approximate solution for the target value.

### TECHNICAL FIELD

The present disclosure relates to a head-up display mounted on a vehicle.

### BACKGROUND ART

There is a head-up display disclosed in Patent Document 1. In this head-up display, display light emitted from a liquid crystal display is reflected by a plurality of reflecting mirrors, thereafter passes through a translucent dust cover that covers an emission port, and is further reflected by a windshield of a vehicle, so that a virtual image of the display light is visually recognized by eyes of a driver.

### PRIOR ART DOCUMENT

### Patent Document

Patent Document 1: Japanese Patent Laid-open No. 2021-14153

### SUMMARY OF THE INVENTION

### Problems to be Solved by the Invention

However, an inventor of the present disclosure has found that, in the process of passing through or being reflected by the optical elements such as the reflecting mirrors, the translucent dust cover, and the windshield, the display light is influenced by arrangement of the optical elements, or the like to cause unintended polarization or luminance reduction.

In view of the above problem, an object of the present disclosure is to improve display quality of a head-up display.

### Solution to Problem

In order to solve the above problem, a head-up display of the present disclosure includes a display element that emits display light representing vehicle information, a case that houses the display element, and has an emission port which emits the display light to outside, an optical element including a translucent dust cover that covers the emission port, and a phase element that includes a plurality of phase difference plates having different polarization characteristics, and is disposed at a predetermined inclination with respect to a principal ray of the display light.

Further, in order to solve the above problem, a method for designing a head-up display of the present disclosure is a method for designing a head-up display that allows display light emitted from a display element to be visually recognized via an optical element and a phase element, the phase element including a plurality of phase difference plates having different polarization characteristics, and disposed on an optical path of the display light at a predetermined inclination with respect to a principal ray of the display light, and the method for designing a head-up display includes a first step of setting a propagation characteristic of light of the optical element, and a second step of setting a target value of emission light of the optical element and calculating a polarizing characteristic of each of the plurality of phase difference plates and the inclination serving as an approximate solution of the target value.

### Effect of the Invention

According to the present disclosure, display quality of a virtual image displayed by a head-up display is improved.

### BRIEF DESCRIPTION OF THE DRAWINGS

FIG. 1 is a schematic configuration diagram of a head-up display.

FIG. 2 is a diagram illustrating light propagation of the head-up display.

FIG. 3 is a diagram illustrating arrangement of a phase element.

FIG. 4 is a diagram illustrating a design procedure of the phase element.

### MODE FOR CARRYING OUT THE INVENTION

A head-up display HUD of the present disclosure will be described with reference to the accompanying drawings.

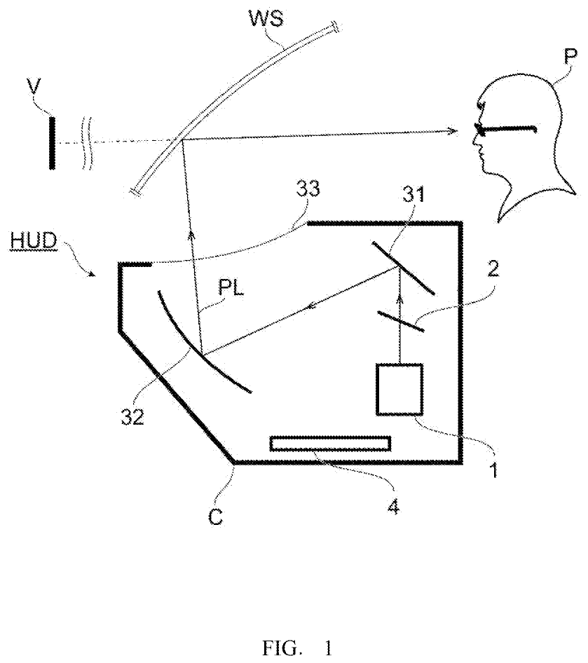

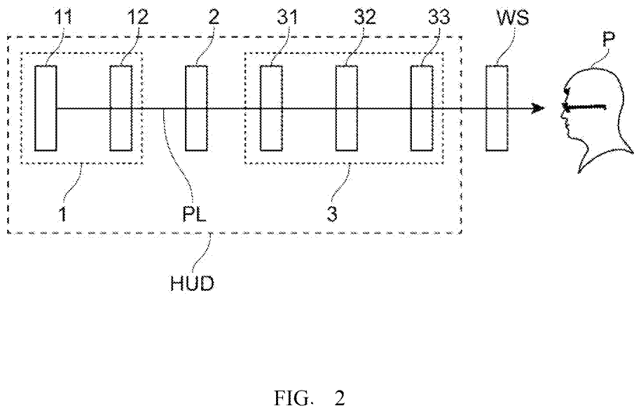

Reference is made to FIG. 1 and FIG. 2. The head-up display HUD is mounted in an instrument panel of a vehicle, and projects display light PL toward a windshield WS of the vehicle in front of eyes of an occupant (mainly; a driver) P. The occupant P can see a virtual image V of the display light PL in front of the windshield WS by the display light PL reflected by the windshield WS.

The head-up display HUD includes a display element 1, a phase element 2, a first reflecting mirror 31, a second reflecting mirror 32, a control unit 4, and a case C formed with an emission port covered with a translucent dust cover 33.

The display element 1 emits display light representing vehicle information. Of the display light, a reference ray passing through the center of the display element 1 is defined as a principal ray PL. The display element 1 is, for example, a liquid crystal display, and includes a light source 11 and a liquid crystal panel 12. The display element 1 may be an organic EL display, a projector, or the like, in addition to the liquid crystal display.

The light source 11 is a backlight that illuminates the liquid crystal panel 12. The light source 11 is, for example, an LED that emits white light. Although not illustrated, various lenses such as a collimator lens that converts light emitted from the light source 11 into uniform parallel light are disposed between the light source 11 and the liquid crystal panel 12.

The liquid crystal panel 12 is, for example, a thin film transistor (TFT) type active matrix panel. The liquid crystal panel 12 includes a liquid crystal cell composed of a pair of transparent substrates and a liquid crystal layer sealed between the substrates, and polarizing filters facing each other with the liquid crystal cell interposed therebetween. In the liquid crystal panel 12, when a drive voltage is applied to the liquid crystal layer under control of the control unit 4, the orientation of liquid crystal molecules of the liquid crystal layer is controlled, and the liquid crystal panel 12 can switch between a transmissive state and a non-transmissive state for each of the pixels arranged in a matrix. Non-polarized light of the light source 11, which passes through the pixels in the transmission state, is deflected into linearly polarized light and passes through the pixels, and therefore the liquid crystal panel 12 can also be defined as a deflector.

The liquid crystal panel 12 is controlled by the control unit 4, and displays a predetermined image by switching between the transmissive state and the non-transmissive state for each pixel. This image is, for example, a figure or a number representing vehicle information such as a traveling speed of a vehicle, a vehicle warning, or route guidance information.

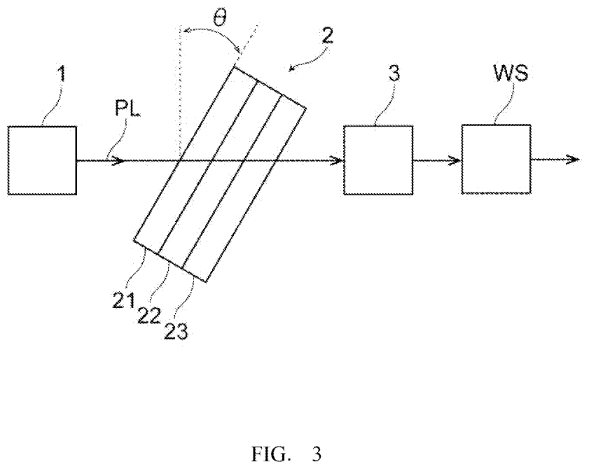

The phase element 2 is a laminated phase difference plate in which a plurality of phase difference films for generating different phase differences are laminated. The different phase difference means that, for example, an azimuth angle or an ellipticity angle with respect to a specific wavelength is different. In addition, the phase element 2 is disposed on an optical path through which the display light PL passes so as to be inclined by θ degrees with respect to the principal ray of the display light PL emitted from the display element 1. As illustrated in FIG. 3, in this embodiment, the phase element 2 is disposed between the display element 1 and an optical element 3. The phase element 2 is formed by laminating three phase difference films 21, 22, and 23 made of resin. The inclination θ of the phase element 2 and characteristics of the phase difference films 21 to 23 will be described in detail in “Design Procedure for Phase Element 2” which will be later described.

An optical member that reflects or transmits the display light PL on an optical path through which the display light PL reaches the eyes of the occupant P is defined as the optical element 3. In this embodiment, the optical element 3 corresponds to the first reflecting mirror 31, the second reflecting mirror 32, the translucent dust cover 33, and the windshield WS. Herein, the optical element included in the head-up display HUD is defined as an internal optical element. The internal optical element corresponds to the first reflecting mirror 31, the second reflecting mirror 32, and the translucent dust cover 33. In addition, not the internal optical element, but an optical element disposed outside the head-up display HUD is defined as an external optical element. The external optical element corresponds to a windshield WS.

The first reflecting mirror 31 is a reflecting mirror that reflects the display light PL, which passes through the phase element 2, toward the second reflecting mirror 32. The first reflecting mirror 31 is, for example, a plane mirror.

The second reflecting mirror 32 is a reflecting mirror that reflects the display light PL reflected by the first reflecting mirror 31 toward the emission port of the case C. The second reflecting mirror 32 is, for example, a concave mirror.

The translucent dust cover 33 is a transparent resin film made of acrylic resin, polycarbonate resin, or the like. The translucent dust cover 33 covers the emission port formed in the case C, and is curved along the emission port.

The control unit 4 is a circuit board having a microcontroller for controlling the display element 1.

The case C is a black resin or metal case having a light shielding property. The case C houses the display element 1, the phase element 2, the first reflecting mirror 31, the second reflecting mirror 32, and the control unit 4.

### (Design Procedure for Phase Element 2)

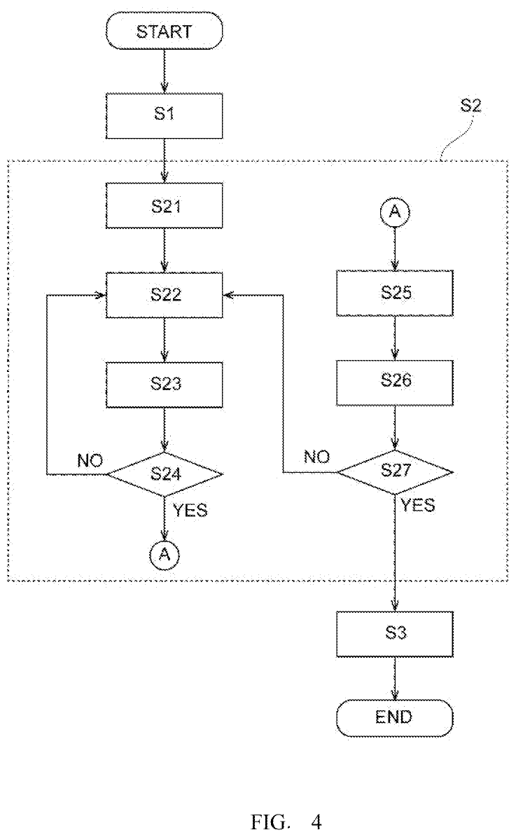

A design procedure for the phase element 2 will be described below with reference to FIG. 4. Optimum values (approximate solutions) of characteristics and arrangement of the three phase difference films 21, 22, and 23 are obtained by the following design procedure.

### (Step S1)

In Step S1, quantitative evaluation values of incident light and emission light of each optical element 3 in three wavelengths of red light, green light and blue light are measured, and a propagation characteristic of light of each optical element 3 is calculated from the quantitative evaluation values. This measurement is performed without the phase element 2. After Step S1 is performed, Step S2 is performed.

In this embodiment, the wavelength of red light is, for example, 488 nm. The wavelength of green light is, for example, 532 nm. The wavelength of blue light is, for example, 632 nm. The optical elements 3 are the first reflecting mirror 31, the second reflecting mirror 32, the translucent dust cover 33, and the windshield WS which are described above. Herein, the measurement of the quantitative evaluation value of the incident light of the first reflecting mirror 31 positioned at the most front stage is performed in a state in which the phase element 2 is not present, and therefore the quantitative evaluation value is also a quantitative evaluation value of emission light from the display element 1.

The measurement of the quantitative evaluation values of the incident light and the emission light of the optical element 3 indicates, for example, a Stokes parameter.

As a specific example, as Stokes parameters of incident light a (λ) of one optical element 3 at a wavelength λ, four Stokes parameters of Sa0 (λ), Sa1 (λ), Sa2 (λ), and Sa3 (λ) are measured. In addition, as Stokes parameters of incident light b (λ) of one optical element 3 at a wavelength λ, four Stokes parameters of Sb0 (λ), Sb1 (λ), Sb2 (λ), and Sb3 (λ) are measured.

A propagation characteristic of light of the optical element 3 is, for example, an amplitude ratio angle and a phase difference. The amplitude ratio angle and the phase difference can be derived from the Stokes parameters described above.

### (Step S2)

In Step S2, a target value of the emission light b (λ) at the wavelength λ of the optical element 3 at the final stage is set, and the polarization characteristic and the arrangement of the phase element 2 that satisfy the target value (or approximate the target value) are calculated. An optimum solution (approximate solution) of the polarization characteristic and the arrangement of the phase element 2 is calculated by a genetic algorithm. The detailed procedure of Step S2 of this genetic algorithm is indicated in the following Steps S21 to S27, and the Step S21 is first performed.

### (Step S21)

In Step S21, setting of various condition values of the genetic algorithm is performed. After the Step S21 is performed, Step S22 is performed.

Specific examples of various condition values in the Step S22 are as follows. In this example, in a case where the occupant P views the virtual image V with naked eyes without wearing polarized sunglasses, the phase element 2 having the highest display luminance efficiency is obtained. In addition, an initial gene of the phase element 2 has no polarization characteristic and no inclination, and does not influence the display light PL at all.
(1) Initial value of setting value of phase element 2 (initial gene)
(1A) Inclination θ of entire phase element 2=0
(1B) No polarization characteristic of phase difference films 21 to 23
(2) Evaluation function: S-polarized component of emission light from optical element 3 at final stage at each wavelength of the discretization number of spectrum
(3) Crossover method: one point crossover
(4) Crossing rate: 90%
(5) Mutation rate: 10%
(6) Selection method: elite selection (20% selection)
(7) Initial population: 100 individuals
(8) Initial population selection method: random selection
(9) Number of generations: 1000 generations
(10) Polarization analysis method: Jones matrix method
(11) Refractive index dispersion of material: use of phase difference measured by Senarmont method and ratio of each wavelength

### (Step S22)

In Step S22, one gene is selected from a population of a current generation and set as a set value of the phase element 2, and propagation of light is simulated. This simulation simulates propagation of light in which the display light PL emitted from the display element 1 passes through the phase element 2 and each optical element 3. By this simulation, quantitative evaluation values of the incident light and the emitted light of each optical element 3 are calculated. After Step S22 is performed, Step S23 is performed.

### (Step S23)

In Step S23, an evaluation value is calculated on the basis of an evaluation function. This evaluation value is an evaluation value of the set value (gene) of the phase element 2. After Step S23 is performed, Step S24 is performed.

### (Step S24)

In Step S24, it is determined whether there is any unselected gene in a current generation population. In a case where there is no unselected gene, Step S25 is performed. In a case where there are unselected genes, one of the unselected genes is selected and Step S22 is performed again.

### (Step S25)

In Step S25, the genes of the current generation population are selected. In this embodiment, the genes of the current generation population are selected by elite selection (20% selection). After Step S25 is performed, Step S26 is performed.

### (Step S26)

In Step S26, crossover and mutation are performed on the basis of the genes of the current generation population, and a population of a next generation. In this embodiment, single point crossover is adopted as a crossover method, and a mutation rate is 10%. After Step S26 is performed, Step S27 is performed.

### (Step S27)

In Step S27, it is determined whether selection of the next generation is unnecessary. In a case where the current generation reaches the number of generations set in Step S22, it is determined that the selection of the next generation is unnecessary, and Step S3 is performed. In a case where the current generation does not reach the number of generations set in Step S22, the next generation population created in Step S26 is selected as the current generation population, and Step S22 is performed again.

### (Step S3)

In Step S3, a gene having the highest evaluation value is selected from the genes obtained in the Step S2 (Steps S21 to S27).

In this embodiment, the phase element 2 having the gene obtained in Step S3 as the set value is obtained as an optimum phase element having the following characteristics when the following phase difference films 21 to 23 are arranged at an inclination θ of 46°.

### (Characteristics of Phase Difference Film 21)

In the phase difference film 21, the azimuth angle of the wavelength 488 nm is −88 deg. and the ellipticity angle is 2.2 deg. Further, the azimuth angle of the wavelength 532 nm is −88 deg., and the ellipticity angle is 15 deg. In addition, the azimuth angle of the wavelength 632 nm is −87 deg. and 33 deg.

(Characteristics of Phase Difference film 22)

In the phase difference film 22, the azimuth angle of the wavelength 488 nm is −42 deg., and the ellipticity angle is 4.4 deg. Further, the azimuth angle of the wavelength 532 nm is 39 deg., and the ellipticity angle is −12 deg. In addition, the azimuth angle of the wavelength 632 nm is −29 deg. and 20 deg.

### (Characteristics of Phase Difference Film 23)

In the phase difference film 23, the azimuth angle of the wavelength 488 nm is −34 deg., and the ellipticity angle is −34 deg. Further, the azimuth angle of the wavelength 532 nm is −20 deg. and the ellipticity angle is 32 deg. In addition, the azimuth angle of the wavelength 632 nm is −7.9 deg. and 26 deg.

As described above, the plurality of phase difference films 21 to 23 of the phase element 2 obtained by the optimal solution (approximate solution) are designed to cancel out adverse effects such as stacked minute polarized light due to the arrangement of the optical elements 3, and are designed on the basis of a completely different concept from a wavelength plate such as a 24 plate that simply converts linearly polarized light emitted from the display element 1 into circularly polarized light. In particular, by using the plurality of phase difference films 21 to 23, it is possible to widely cancel the influence of the plurality of optical elements 3.

The above is the design procedure of the phase element 2.

In the above embodiment, the phase element 2 includes the three phase difference films 21 to 23, but the present disclosure is not limited to this. At least two phase difference films may be used, and for example, five or seven phase difference films may be used. In a preferred embodiment, the number of phase difference films of the phase element 2 is preferably set so as to correspond to each optical element 3. In this case, each phase difference film can be designed so as to cancel the corresponding optical element 3, and therefore in a case where there is change in the components of the head-up display, it is possible to cope with the change by adding the phase difference film corresponding to the optical element serving as a change point to the phase element 2, thereby resulting in facilitation of design.

In the above embodiment, the phase element 2 is preferably disposed between the display element 1 and the optical element 3, but the present disclosure is not limited to this. The phase element 2 may be disposed at any place between the display element 1 and the external optical element (windshield WS). For example, the phase element 2 may be disposed between the second reflecting mirror 32 and the translucent dust cover 33 of the internal optical element (the first reflecting mirror 31, the second reflecting mirror 32, and the translucent dust cover 33).

In the above embodiment, when the phase element 2 is designed, the light emitted from the windshield WS of the external optical element which is the optical element 3 at the final stage is evaluated, but the present disclosure is not limited to this. In a case where the head-up display HUD alone is evaluated, the light emitted from the translucent dust cover 33, which is disposed at the final stage of the internal optical element, may be evaluated. Alternatively, light emitted from an arbitrary optical element 3 may be evaluated.

In the above embodiment, the design of the phase element 2, which is optimum design in a case where the occupant P views the virtual image V with the naked eyes without wearing polarized sunglasses, is performed, but the present disclosure is not limited to this. The present disclosure is suitable for obtaining the phase element 2 that cancels out an adverse effect due to the arrangement of the optical element 3 or the like when desired emission light is obtained.

For example, the design of the phase element 2, which is optimum design in a case where the occupant P wears polarized sunglasses to view the virtual image V, can be achieved by setting an evaluation function for evaluating “the intensity of a P-polarized component of the light emitted from the optical element 3 at the final stage at each wavelength of the discretization number of the spectrum”.

In a case where the occupant P designs the phase element 2 for obtaining uniform display quality regardless of the wearing state of the polarized sunglasses, it is possible to cope with the design by setting an evaluation function for evaluating “difference in intensity between the S-polarized component and the P-polarized component of the light emitted from the optical element 3 at the final stage at each wavelength of the discretization number of the spectrum”. Alternatively, the phase element 2 may be designed so as to be closest to circularly polarized light by an evaluation function for evaluating “the flatness ratio of the polarization component of the light emitted from the optical element 3 at the final stage”.

In the above embodiment, the initial gene of the phase element 2 is set so as not to influence the display light PL at all without polarization characteristics and inclination, but the present disclosure is not limited to this. In order to easily obtain an optimal solution (approximate value) of the genetic algorithm, predetermined values of the polarization characteristic and the inclination are preferably set.

As described above, the head-up display of the present disclosure includes the display element 1 that emits the display light PL representing vehicle information, the case C that houses the display element 1 and has the emission port which emits the display light PL to the outside, the optical element 3 including the translucent dust cover 33 that covers the emission port, and the phase element 2 that includes the plurality of phase difference plates 21 to 23 having different polarization characteristics and is disposed at the predetermined inclination θ with respect to the principal ray of the display light PL.

With such a configuration, an adverse effect on the display light PL, which is caused by the arrangement of the display element 1 and the optical element 3, can be canceled by the phase element 2 to suppress decrease in display quality.

In other words, the inventor of the present disclosure has found the problem that the adverse effect such as polarization occurs due to the difference in the incident angle of the display light PL onto the first reflecting mirror 31, the second reflecting mirror 32, and the translucent dust cover 33, and has found that it is possible to solve this problem by providing the phase element 2 that cancels the adverse effect due to the optical element 3.

Further, the method for designing the head-up display of the present disclosure is the method for designing the head-up display that allows the display light PL emitted from the display element 1 to be visually recognized via the optical element 3 and the phase element 2. In this design method, the phase element 2 includes the plurality of phase difference plates 21 to 23 having different polarization characteristics, and is disposed on the optical path of the display light PL at the predetermined inclination θ with respect to the principal ray of the display light PL. The method further includes first Step S1 of setting a propagation characteristic of light of the optical element 3, and second Step S2 of setting a target value of emission light of the optical element 3 and calculating a polarizing characteristic of each of the plurality of phase difference plates and the inclination θ serving as the approximate solution of the target value.

With such a configuration, it is possible to design the phase element 2 that cancels out the adverse effect on the display light PL caused by the arrangement of the display element 1 and the optical element 3.

### DESCRIPTION OF REFERENCE NUMERALS

1: display element
11: light source
12: liquid crystal panel (polarizer)
2: phase element
21: phase difference film (phase difference plate)
22: phase difference film (phase difference plate)
23: phase difference film (phase difference plate)
3: optical element (internal optical element)
31: first reflecting mirror
32: second reflecting mirror
33: translucent dust cover
4: control unit
WS: windshield (external optical element)
HUD: head-up display
PL: display light

1. A head-up display comprising:
a display element that emits display light representing vehicle information;
a case that houses the display element, and has an emission port which emits the display light to outside;
an optical element including a translucent dust cover that covers the emission port; and
a phase element that includes a plurality of phase difference plates having different polarization characteristics, and is disposed at a predetermined inclination with respect to a principal ray of the display light.

2. The head-up display according to claim 1, wherein
the plurality of phase difference plates are laminated.

3. The head-up display according to claim 1, wherein
the phase element is disposed between the display element and the optical element.

4. A method for designing a head-up display that allows display light emitted from a display element to be visually recognized via an optical element and a phase element, the phase element including a plurality of phase difference plates having different polarization characteristics, and disposed on an optical path of the display light at a predetermined inclination with respect to a principal ray of the display light, the method for designing a head-up display comprising:
a first step of setting a propagation characteristic of light of the optical element; and
a second step of setting a target value of emission light of the optical element and calculating a polarizing characteristic of each of the plurality of phase difference plates and the inclination serving as an approximate solution of the target value.

5. The method for designing a head-up display according to claim 4, wherein
in the first step, the propagation characteristic is derived from a measured value of a quantitative evaluation value of the optical element without the phase element, and in the second step, the approximate solution is searched by a genetic algorithm.

6. The method for designing a head-up display according to claim 5, wherein
an evaluation function of the genetic algorithm evaluates intensity of S-polarized light or P-polarized light at at least three wavelengths of the emission light of the optical element.

7. The method for designing a head-up display according to claim 5, wherein
an evaluation function of the genetic algorithm evaluates a flatness ratio of a polarization component of polarized light at at least three wavelengths of the emission light of the optical element.
